(19) United States
(12) Patent Application Publication
(10) Pub. No.: US 2006/0243679 A1
(43) Pub. Date: Nov. 2, 2006

(54) Computer monitor organizer

(76) Inventor: Mark Dickerson, Saratoga, CA (US)

Correspondence Address: Sean M. Fitzgerald, 3182 Campus Drive#342, San Mateo, CA, 94402-3123, US

(21) Appl. No.: 11/116,945

(22) Filed: Apr. 27, 2005

(51) Int. Cl. B42F 17/00

(52) U.S. Cl. 211/10; 211/118

(57) ABSTRACT

An organizer is adapted for use with a viewing device such as a computer monitor. The monitor organizer includes a left organizer module, a right organizer module, and a connector 103. The organizer modules may be formed to provide holders or other organizing functionality such as document holders, cell phone holders, writing instrument holders, envelope holders, post-it holders, business card holders, file or paper holders, and the like. The organizer modules may be detachable or permanent, and may allow additional modules to be attached. A rear module or modules may also be included, and the monitor organizer may be adapted to work on a variety of viewing devices including CRT monitors as well as flat panel monitors. The monitor organizer may also expand or contract to accommodate monitors of different external dimension.

### BACKGROUND

1. Field of the Invention

The present invention relates, generally, to organizers. More particularly, the present invention relates to systems for providing organizational capability to a computer monitor.

2. Related Background

The typical work or home environment suffers from clutter on a desktop or around a computer. Computer users often use pencils, pens, note pads, post-its, highlighters, electronic organizers such as PDAs, cell phones, desk calendars, paperclips, business cards and holders, as well as many other items. Various conventional organizers provide the ability to organize some of these items. One type of conventional organizer sits on the top of a desk and has multiple bins adapted to hold office and personal items. While conventional desktop organizers may reduce clutter, they also take up desk space, which is often in a premium, especially in office cubes or home computer areas.

One example of an organizer adapted for use with a computer monitor is given in U.S. Pat. No. 6,412,744 B1 issued to Wollam et al. The Wollam organizer provides a flat surface surrounding the monitor. This flat surface may be used to place “items such as notes, calendars, nameplates, pads, mirrors, writing implements, and keys” which are mounted on the flat surface adjacent the computer screen. Among the disadvantages of the Wollam organizer is the bulk of the organizer. The flat area significantly increases the size of the area taken up by the monitor. In addition to the negative visual impact, this may limit the view past the monitor to windows or obstruct other desk items such as lamps, cabinets or shelving. Additionally, the Wollam organizer

Accordingly, the present invention seeks to overcome these and other disadvantages and limitations in conventional organizers.

### SUMMARY

The present invention provides a organizer adapted for use with a viewing device such as a computer monitor. The monitor organizer includes a left organizer module, a right organizer module, and a connector 103. The organizer modules may be formed to provide holders or other organizing functionality such as document holders, cell phone holders, writing instrument holders, envelope holders, post-it holders, business card holders, file or paper holders, and the like. The organizer modules may be detachable or permanent, and may allow additional modules to be attached. A rear module or modules may also be included, and the monitor organizer may be adapted to work on a variety of viewing devices including CRT monitors as well as flat panel monitors. The monitor organizer may also expand or contract to accommodate monitors of different external dimension.

### BRIEF DESCRIPTION OF THE FIGURES

FIG. 1 is perspective view of a monitor organizer, according to one possible embodiment.

FIG. 2 is a front view of the monitor organizer shown in FIG. 1.

FIG. 3 is a top view of the monitor organizer shown in FIG. 1.

FIG. 4 is a left side view of the monitor organizer shown in FIG. 1.

FIG. 5 is a right side view of the monitor organizer shown in FIG. 1.

FIG. 6 is a bottom view of the monitor organizer shown in FIG. 1.

FIG. 7 is a perspective view of an alternate embodiment of the monitor organizer shown on a flat panel monitor, according to one possible embodiment.

FIG. 8 is a right side cross-sectional view of an alternate embodiment of a monitor organizer adapted for use with a flat panel monitor, according to one possible embodiment.

FIG. 9 is a perspective view of an alternate embodiment of the monitor organizer which adjusts to accommodate monitors of different size, according to one possible embodiment.

FIG. 10 is a perspective view of an alternate embodiment of the monitor organizer, according to one possible embodiment.

FIG. 11 is a close-up perspective view of the monitor organizer shown in FIG. 10 illustrating the extendable document holder, according to one possible embodiment.

FIG. 12 is a perspective view of an alternate embodiment of the monitor organizer, according to one possible embodiment.

FIG. 13 is a perspective view of an alternate embodiment of the detachable organizer module monitor organizer shown in FIG. 12 illustrating different possible monitor organizer modules FIG. 14 is a perspective view of an alternate embodiment of the detachable organizer module illustrating an alternate attachment system.

FIG. 15 is a perspective view of an alternate embodiment of the detachable organizer module illustrating an alternate attachment system.

FIG. 16 is a perspective view of an alternate embodiment of the monitor organizer having a storage bin, according to one possible embodiment

FIG. 17 is a right side cross-sectional view of an alternate embodiment of a monitor organizer shown in FIG. 16.

### DETAILED DESCRIPTION

The present invention is described in the context of a specific embodiment. This is done to facilitate the understanding of the features and principles of the present invention and the present invention is not limited to this embodiment. In particular, the present invention is described in the context of an organizer adapted for use with a computer monitor. The directional terms front and back are meant to indicate relative positions of the organizer in relation to the viewing screen of a computer monitor. Specifically, the front of the organizer refers to the side of the organizer visible to a person sitting in front of a computer monitor and viewing the screen of the monitor.

In the following figures like objects are provided with the same identifying number as an aid in understanding the present invention.

### Monitor Organizer

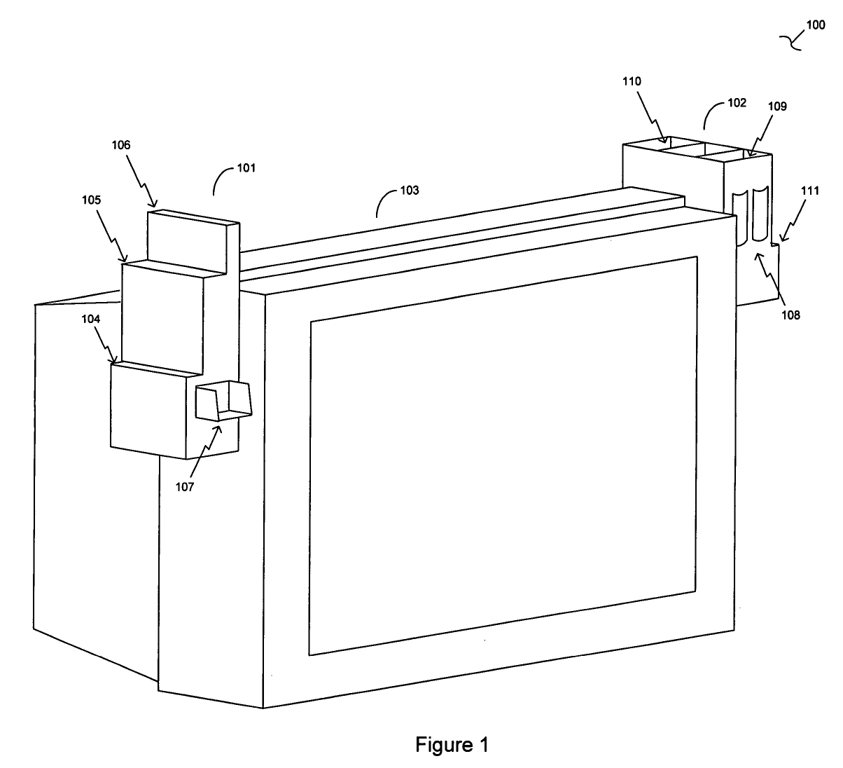

FIG. 1 illustrates a perspective view of a monitor organizer 100. The monitor organizer includes a left organizer frame 101, a right organizer frame 102, and a connector 103. In one possible embodiment, the left organizer frame 101 includes a calculator holder 104, a notepad holder 105, and an envelope holder 106. Additionally, a cell phone holder 107 may also be included, allowing the cell phone to face forward, where it can readily be seen and its screen read (aiding in viewing caller ID). The calculator holder 104, notepad holder 105 and envelope holder 106 are formed to accommodate the size and shape of the respective objects they are designed to hold, and also are formed to provide ready access to the objects they hold. In one possible embodiment, the right organizer frame 102 includes at least one writing instrument holder 108, a writing instrument holder bin 109, a paperclip holder 110, and a business card holder 111. The writing instrument holder 108 may be specifically adapted to hold pencils, pens, or another given writing instrument, or may be a general writing instrument holder capable of holding, without limitation, pencils, pens, markers, highlighters, etc. The writing instrument holder bin 109 may be formed to hold a specific type of wiring instrument, or may be formed as a general writing instrument holder. Additionally, the writing instrument holder bin 109 may be subdivided to form several compartments, to aid in organizing writing instruments. As shown, the business car holder is placed on one side to allow convenient access to business cards without interfering with the other organizer functions of the right organizer frame.

The cell phone holder 107 may be in the form of a cradle. Additionally, the cell phone holder may include a charging unit (not shown), allowing the cell phone to be recharged while placed in the cell phone holder of the monitor organizer. In such an embodiment, the monitor organizer may include a power cord (or a battery) to supply power to the cell phone re-charger.

The cell phone holder may also be adapted to accommodate a PDA device, such as a Palm Pilot™. A PDA holder may also act as a PDA cradle, providing the ability to hot sync the PDA with a computer (such as the computer connected to the monitor the monitor organizer is installed on), PDA recharging, or both. In such an embodiment, the monitor organizer may include a communications cable, or power cable, or both to supply power or communications to the PDA holder.

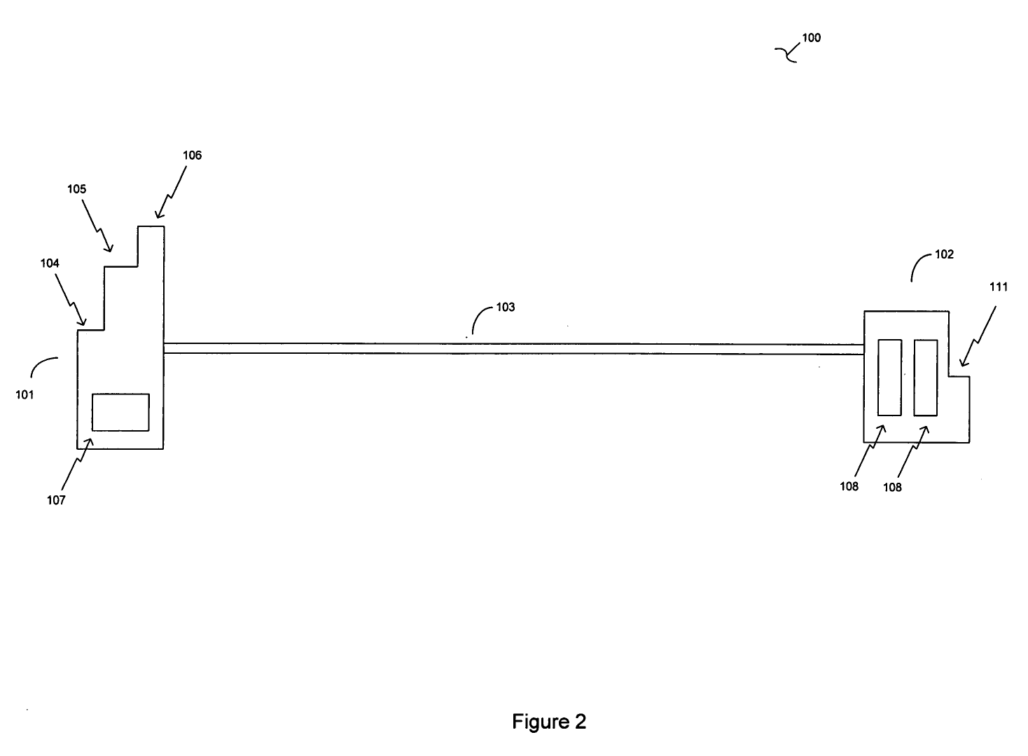

FIG. 2 is a front view of the monitor organizer shown in FIG. 1. The connector 103 provides structural support connecting the left side organizer 101 and the right side organizer frame 102. The left organizer frame 101 and the right organizer frame 102 are formed to extend down from the connector 103, providing additional support between the monitor organizer and a monitor the monitor organizer is installed on. In this manner the monitor organizer forms a pocket between the left organizer frame, right organizer frame and below the connector, where the upper portion of a monitor may be placed to securely hold the monitor organizer in place. In this manner the monitor organizer is able to stay in place as items are placed or removed from it, or as the various components or the monitor organizer, such as a document holder, are extended or used.

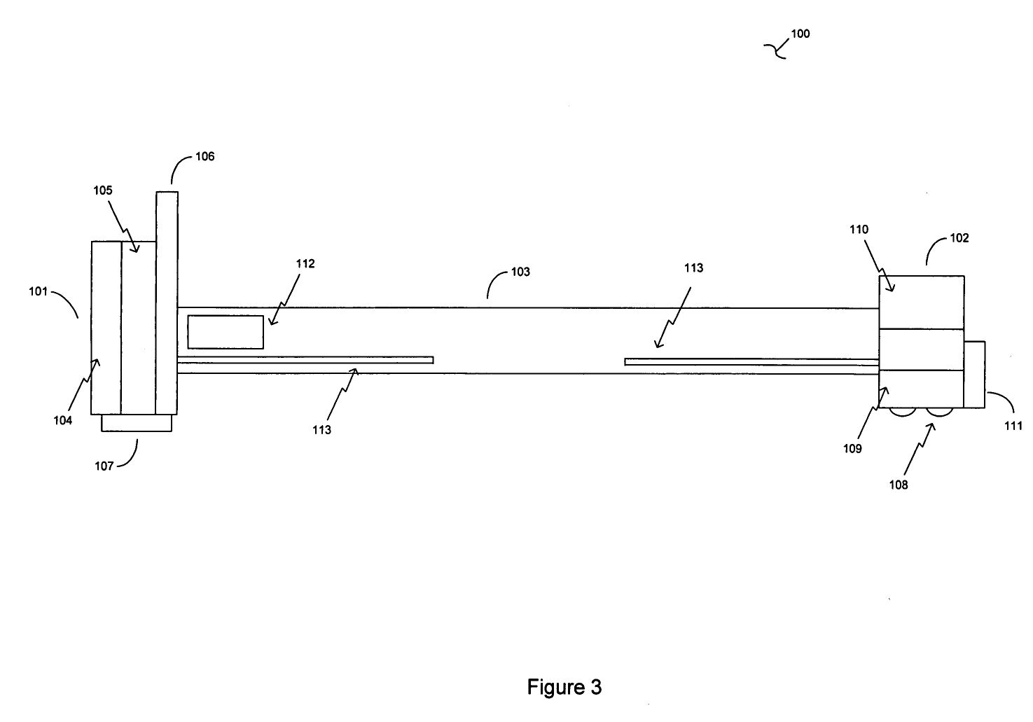

FIG. 3 is a top view of the monitor organizer shown in FIG. 1. The connector 103 may include storage or holding devices, such as a paperclip holder 112 or a photograph document holder 113. The paperclip holder 112 is formed as a depression of size and shape to accommodate paper clips or other items (such as binder clips, thumb tacks, or spare change). The photograph holder is formed as a slot such that a photograph, for example a 3×5 inch or 4×6 inch photograph may be positioned with one edge in the slot will be kept in a substantially upright and viewable position, providing support to a photograph from falling over and laying flat.

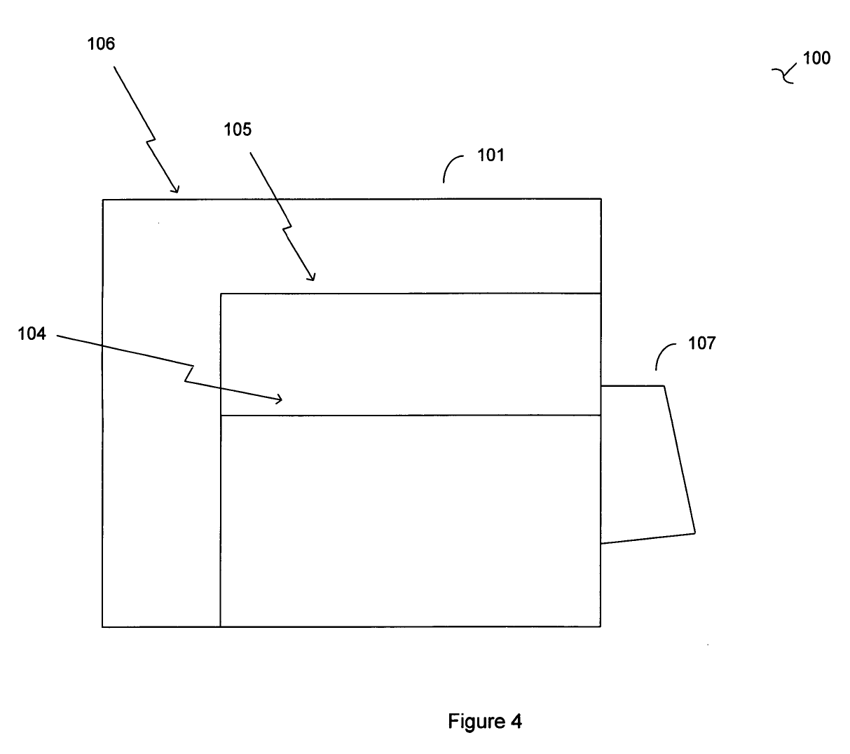

FIG. 4 is a left side view of the monitor organizer shown in FIG. 1. In this embodiment, the left organizer frame 101 includes a calculator holder 104, a notepad holder 105, and an envelope holder 106 formed as a single unit, attached to the connector shown above.

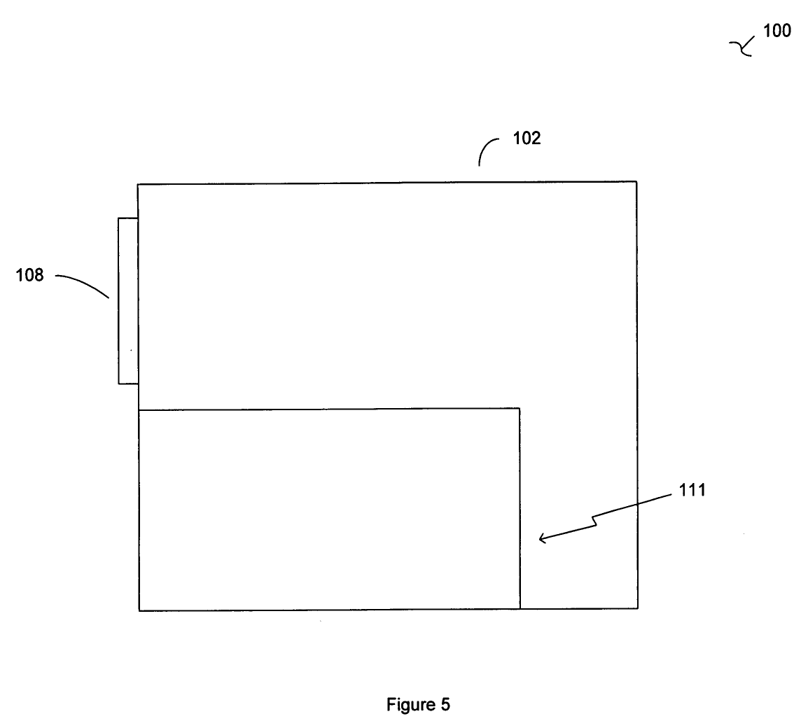

FIG. 5 is a right side view of the monitor organizer shown in FIG. 1. In this embodiment, the right organizer frame 102 includes a writing instrument holder 107, a paperclip holder 108, and a business card holder 109 formed as a single unit, attached to the connector shown above. The business card holder is formed on the side of the right organizer frame from furthest from the monitor, thereby providing access without interfering with the writing instrument holder on the forward facing side of the right organizer frame.

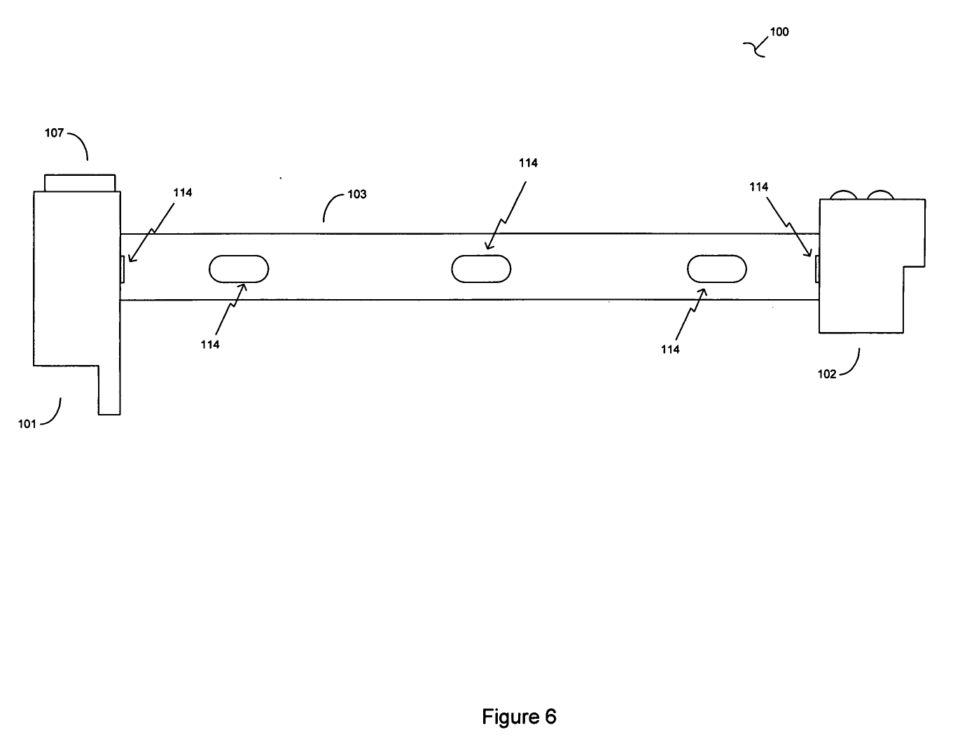

FIG. 6 is a bottom view of the monitor organizer shown in FIG. 1. Contact pads 114 are placed on the side of the monitor organizer that contacts a monitor. The contact pads are formed from a material to prevent the monitor organizer from slipping while in place on a monitor. An example material for a contact pad would include a rubber or similar material. Contact pads may be secured to the monitor organizer by an adhesive or adhesive tape, or may be secured by mechanical means such as screws, clips, retaining clasps, or by any suitable attachment means. The contact pads may be placed on the connector 103 as well as left organizer frame 101 and/or right organizer frame 102.

While the contact pads illustrated in FIG. 6 are oval shaped, the contact pads may be formed in any shape or size depending upon the application of the embodiment. Additionally, a single contact pad covering a large area of the monitor organizer, or even the entire area of the monitor organizer contacting (or facing) the monitor, may be covered by a contact pad in an alternative embodiment.

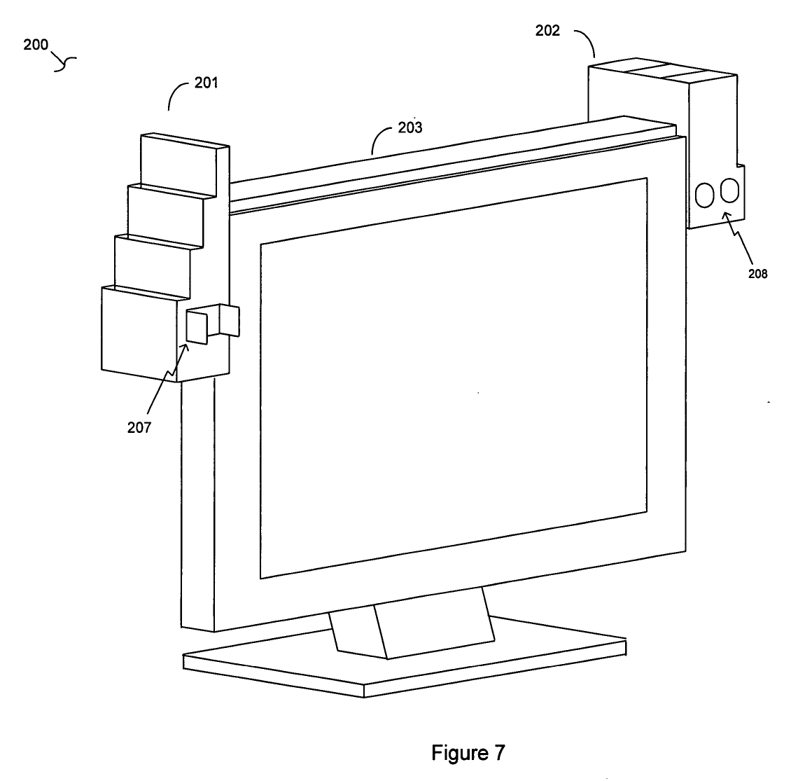

FIG. 7 is a perspective view of an alternate embodiment of a monitor organizer 200 shown installed on a flat panel monitor. The monitor organizer 200 includes a left organizer frame 201, a right organizer frame 202, and a connector 203. The monitor organizer may be adapted in size, shape or placement of securing contact pads to accommodate monitors of different sizes and shapes, including flat panel monitors.

Also illustrated in FIG. 7 is a writing instrument holder 208 designed to hold a writing instrument in a manner protruding out toward a person viewing the monitor. By securing a writing instrument in this manner this embodiment allows the writing instrument to be easily removed from the monitor organizer, or easily placed in the writing instrument holder.

Similarly, an alternative clasp style cell phone holder 207 is used, allowing the monitor organizer 200 to securely hold the cell phone by clamping, or clasping, the phone in the cell phone holder. Such a cell phone holder may also include a recharder or data connection, as described above.

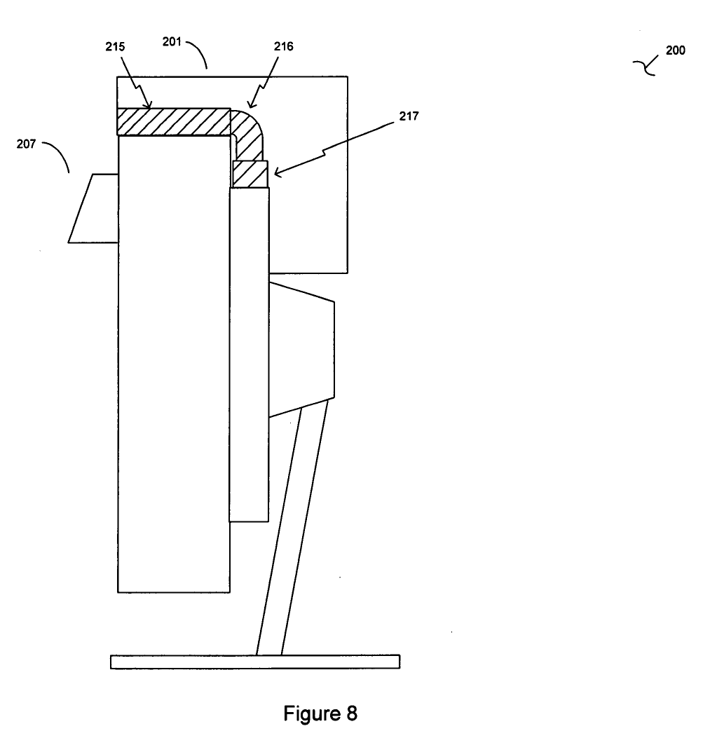

FIG. 8 is a right side cross-sectional view of an alternate embodiment of a monitor organizer 200 shown in FIG. 7. The monitor organizer 200 includes a stabilizing support 216. The stabilizing support 216 connects to the connector 203 which connects the left side organizer 201 to the left side organizer (not shown).

While the embodiment shown in FIG. 8 utilizes a stabilizing support connecting to the monitor organizer connector, alternative embodiments could use a stabilizing support connecting to any (including any combination) of the left side organizer, right side organizer, and/or connector. Additionally, while the stabilizing support was shown above in connection with adaptation to a flat panel monitor, a stabilizing support may be used with any type of viewing device.

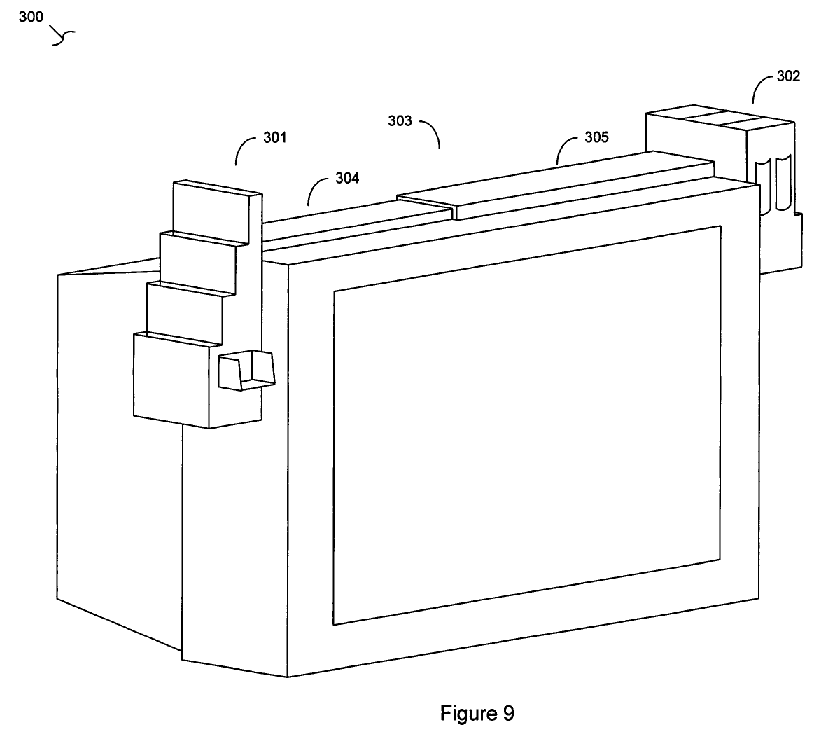

FIG. 9 is a perspective view of an alternate embodiment of the monitor organizer. The monitor organizer 300 includes a left organizer frame 301, a right organizer frame 302, and a connector 303. The connector 303 is formed from a left connector 304 and a right connector 305. The right connector 305 connects to the right organizer 302 and the left connector 304 connects to the left organizer frame 301. The left connector and right connector are connected in a manner to allow the monitor organizer 300 to fit differently sized monitors. In the presently preferred embodiment the left connector and right connector are formed to slide against each other to allow accommodating any sized monitor within the range of the adjustable monitor organizer. In one possible embodiment, the left connector and right connector are formed such that one of the left or right connector slides within the other connector, thus allowing the adjustment of the monitor organizer to fit monitors of different sizes.

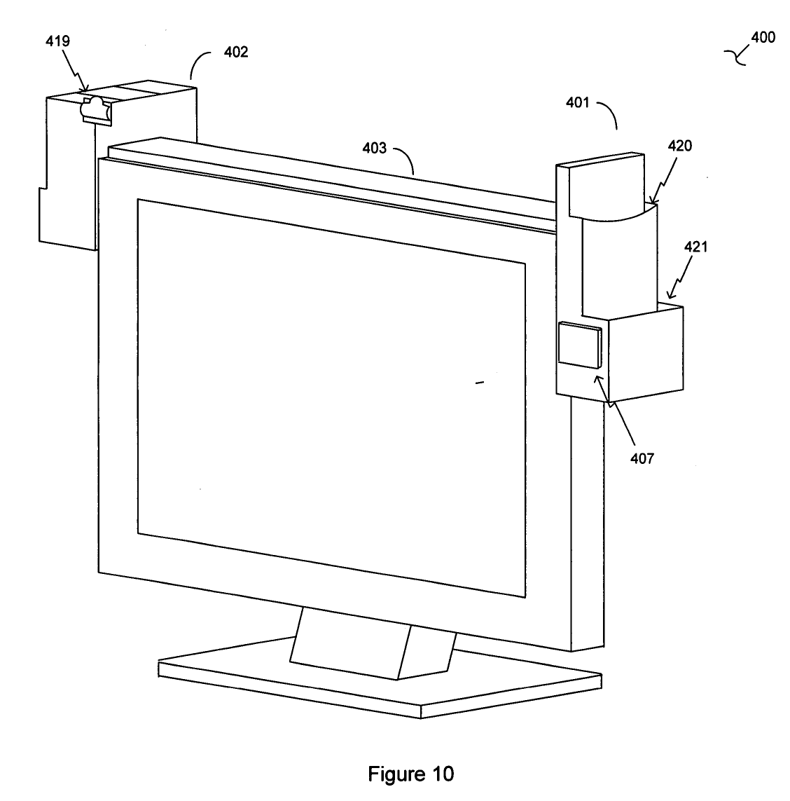

FIG. 10 is a perspective view of an alternate embodiment of monitor organizer 400 with left and right monitor organizers having alternative organizational functionality. The monitor organizer 400 includes a left organizer frame 401, a right organizer frame 402, and a connector 403. In one possible embodiment, the left organizer frame 401 includes a document holder 419. For example, the document holder may be in the form of a clasp or clip, to securely hold a document. The placement of the document holder may be varied in different embodiments to accommodate documents of different sizes.

The organizer frame may also be adapted to provide a holder of eyeglasses as shown by the eyeglass holder 420.

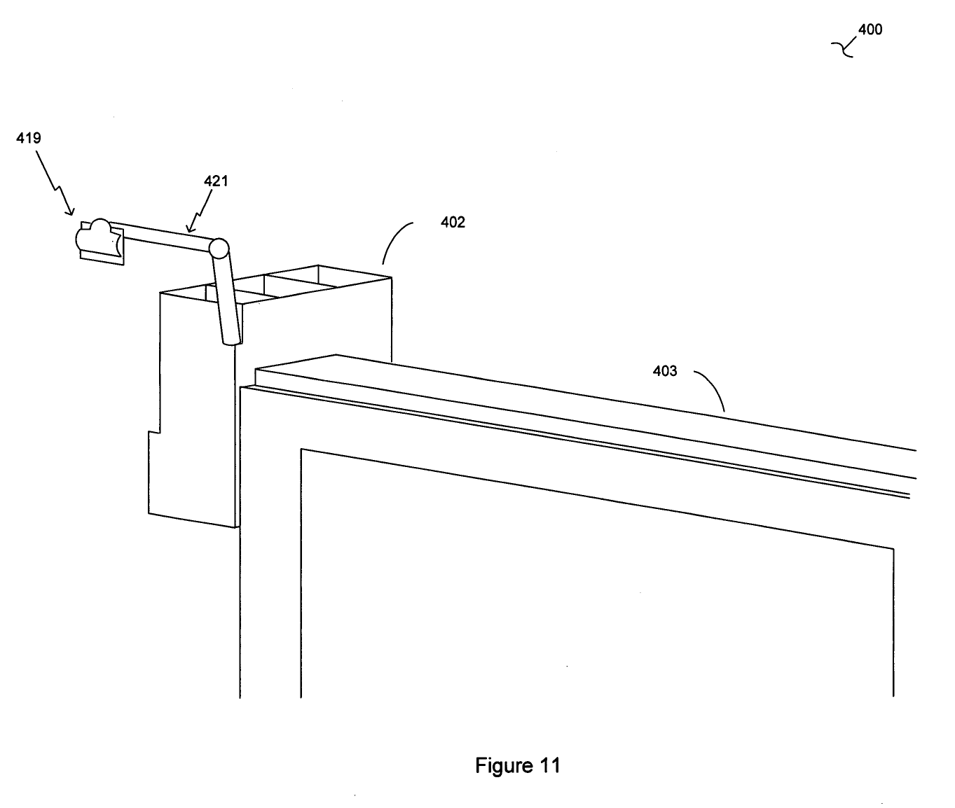

FIG. 11 is a close-up perspective view of an alternate embodiment of the monitor organizer shown in FIG. 10 illustrating an extendable document holder. The document holder 419 is extendable on a document holder arm 420. the document holder arm may include one, or more, joints 422 to allow greater range of positioning the document holder. In the presently preferred embodiment, the extendable document holder is retractable within the organizer frame when the document holder is not in use.

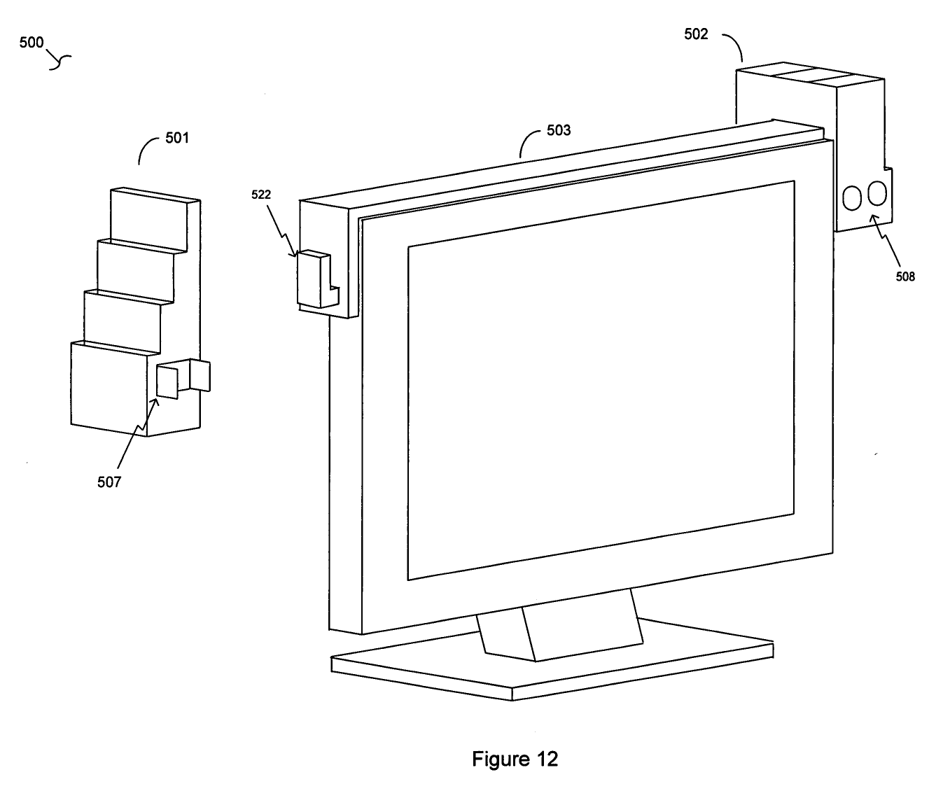

FIG. 12 is a perspective view of an alternate embodiment of the monitor organizer having removable organizer frames. The monitor organizer 500 includes a connector 503, a left frame connector 523, a left organizer module 501, a right frame connector (not shown) and a right organizer module 502. The left organizer module attaches to the connector and right organizer module using the left frame connector. As illustrated, the left connector 523 is a peg type connector. The left organizer module is formed with a connector receptacle (not shown) formed to securely attach to the left frame connector. The size and shape of the frame connector and receptacle of the organizer module may be varied in size and shape to provide secure connection and support to the frame connector (wherein the frame connector may be varied in size, shape and functional components to suit the desired utility of a computer user).

While the embodiment shown in FIG. 12 utilizes both a removable left organizer module and a removable right organizer module, alternate embodiments may have only one removable organizer module, which may either the left organizer module or the right organizer module.

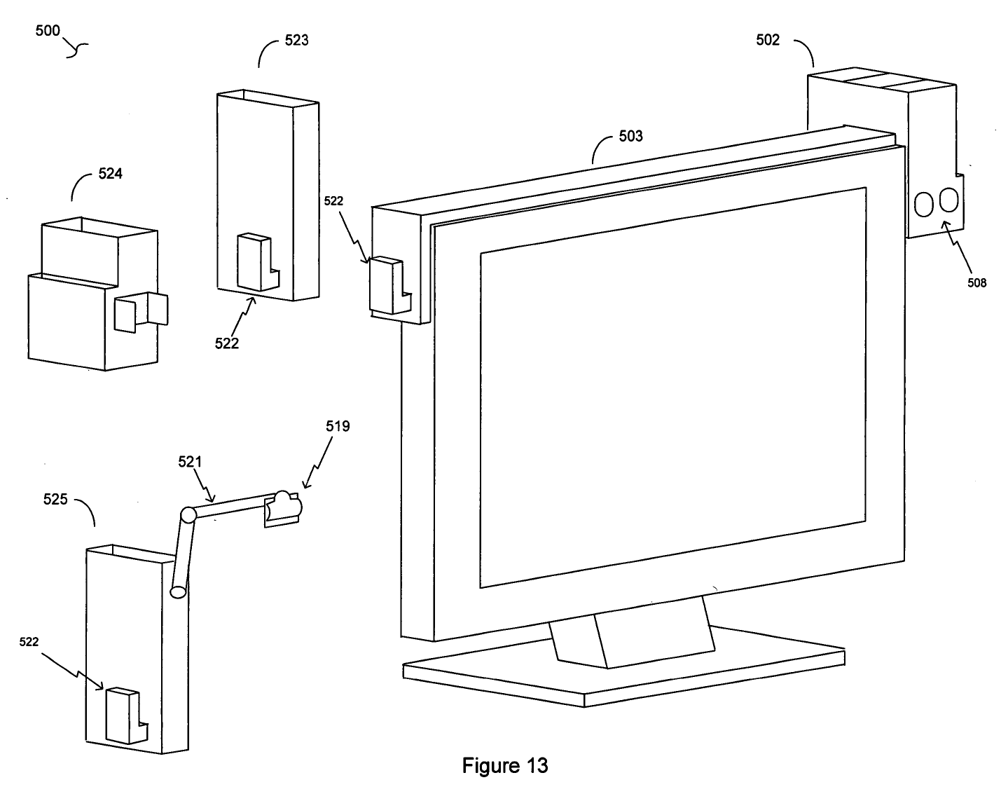

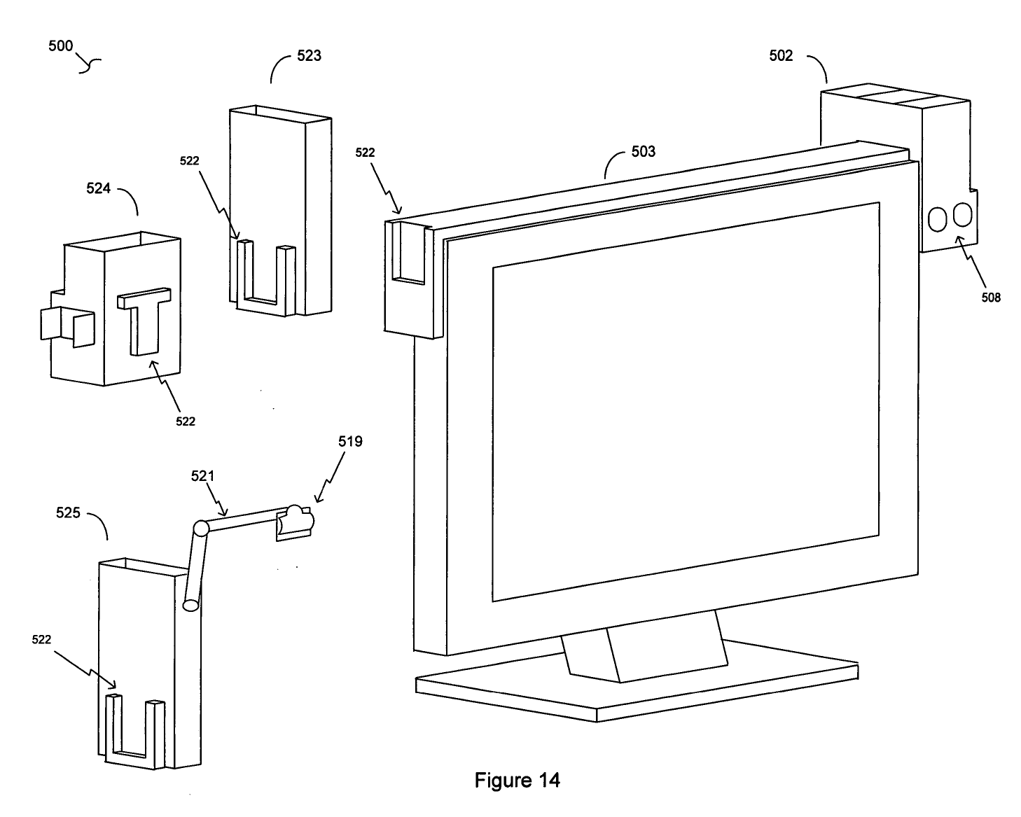

FIG. 13 is a perspective view of an alternate embodiment of the detachable organizer module monitor organizer shown in FIG. 12 illustrating different possible monitor organizer modules. The system of detachable monitor organizer modules allows multiple monitor organizer modules to be added. As illustrated, organizer modules such as a storage bin module 523 (as may be adapted to hold envelopes, notepads, or writing instruments), a multiple storage bin module 524, and a document holder module 525 may be added to the monitor organizer 500. These examples of monitor organizer modules, and other monitor organizer modules, may be added in succession by connecting the connector of either a frame connector or a module connector to a connection receptacle. Monitor organizer modules such as the storage bin module 523 and the document holder module 525 include a module connector 522, allowing additional monitor organizer modules to be added to the monitor organizer when installed on the monitor organizer. In this manner multiple monitor organizer modules may be added, stacked, interchanged or removed to provide the desired organizational functionality of a monitor organizer.

The detachable monitor organizer modules may include multiple organizational functionalities in any combination. For example, the multiple storage bin module 524 includes multiple storage modules, which may be adapted to hold different objects, and may also include a cell phone or PDA holder 507. As another example, the document holder module 525 includes a storage bin. Still other embodiments of monitor organizer modules could combine any combination of functional capabilities in any number.

FIG. 14 is a perspective view of an alternate embodiment of the detachable organizer module monitor organizer illustrating different possible monitor organizer modules. The monitor organizer 500 includes a connector 503, a left frame connector 522, a left organizer module 501, a right frame connector (not shown) and a right organizer module 502. The left organizer module attaches to the connector and right organizer module using the left frame connector. As illustrated, the left connector 522 is a slot type connector. A corresponding organizer module connector 528 is a lug type connector. The lug type organizer module connector 528 is formed to interconnect with the frame connector (either left or right) to securely attach the monitor organizer module to the monitor organizer.

The size and shape of the slot type organizer module connector and lug of the organizer module may be varied in size and shape to provide secure connection and support to the frame connector (wherein the frame connector may be varied in size, shape and functional components to suit the desired utility of a computer user).

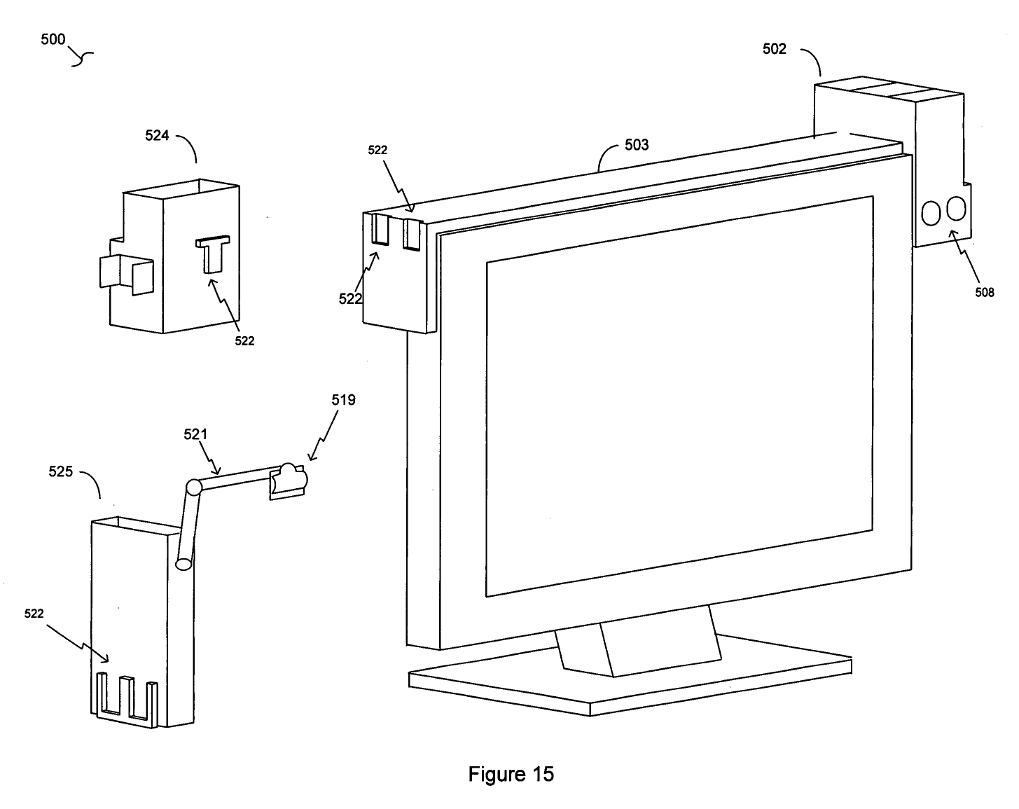

FIG. 15 is a perspective view of an alternate embodiment of the detachable organizer module illustrating an alternate attachment system. The monitor organizer 500 includes two left connectors 522 to allow multiple organizer modules to be attached or removed from either side of the monitor organizer. With two left connectors the monitor organizer allows different configurations of organizing capability, as a user may switch, for example, one organizer module while keeping the other organizer module. Additionally, the organizer modules may each have one or more organizer module connectors, allowing for additional expansion and configuration of the organizer module.

While the monitor organizer is shown in FIG. 15 has two connectors, alternate embodiments may include three or more connectors.

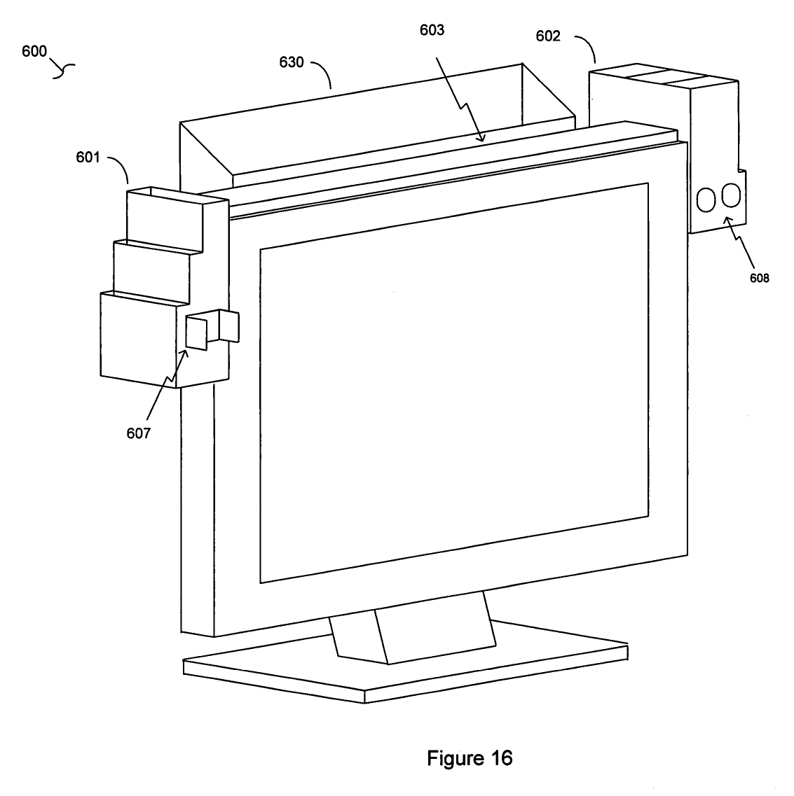

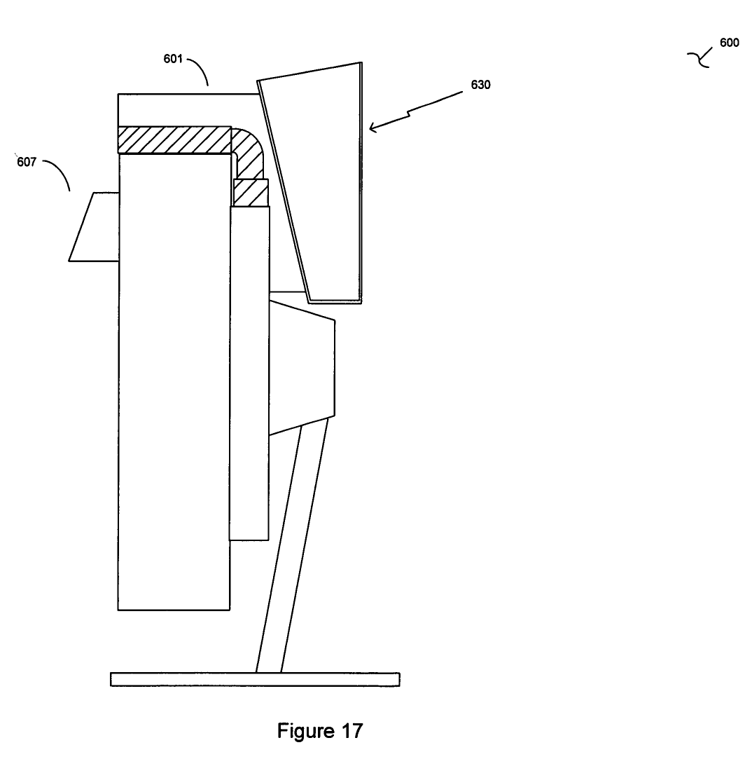

FIG. 16 is a perspective view of an alternate embodiment of a monitor organizer 600 having a rear mounted organizer module 530. FIG. 17 is a right side cross-sectional view of an alternate embodiment of a monitor organizer 600 shown in FIG. 16. The monitor organizer 600 includes a left organizer frame 601, a right organizer frame 602, a connector 603, as well as the rear mounted organizer module 530. As shown, the monitor organizer module 530 is a storage bin. The storage bin rear organizer module 530 is formed to allow documents, folders or paper supplies to be stored in the storage bin rear organizer module.

The storage bin rear organizer module 530 may be attached to the organizer module by a detachable connector, several possible embodiments of which are illustrated in FIGS. 12-15. Alternatively, the storage bin rear organizer module 530 may be attached to the organizer module by a fixed connector, which may attach to the connector 603, to the left organizer frame 601, to the right organizer frame 602, or to any combination of the other components of the monitor organizer 600.

While the storage bin organizer module is shown with a single bin storage container, alternate embodiments may include dividers to allow organization and separation of documents or other items.

While the rear mounted organizer module is shown as a single module, alternate embodiments may use multiple modules, either detachably attached or permanently attached, including any combination of permanent and detachable organizer modules.

The monitor organizer of the present application may be formed from any suitable material or materials. While the presently preferred embodiment is formed from a plastic material, alternative materials may include, without limitation, other synthetic materials such as nylon or PVC, as well as wood, metal, pressboard, or the like.

While the present invention has been described in the context of an organizer used with a computer monitor, alternate embodiments of the present invention could be adapted to be used with other equipment of devices. Specifically, the present invention could be adapted for use with a television (compact, normal or big screen), whether a conventional CRT TV or a flat screen TV, whether mounted on a stand, the wall, or within an entertainment center. Alternate embodiments could be adapted for us with other viewing devices, other electronic or computer systems, or for use with other apparatus.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. An apparatus for use with a display device, comprising:
a frame adapted to the dimensions of said display device;
a first organization module attached to said frame such that the first organizing module is substantially to the side of said display device, the first organizing module including at least one organizing feature selected from the list of: writing instrument holder, note pad holder, document holder, cell phone holder, PDA holder, document holder, envelope holder, and
a second organization module attached to said frame such that the second organizing module is substantially to the side of said display device, the second organizing module including at least one organizing feature selected from the list of: writing instrument holder, note pad holder, document holder, cell phone holder, PDA holder, document holder, envelope holder.

2. The apparatus of claim 1, wherein the first organization module is attached in a manner to allow removal from the frame of the apparatus.

3. The apparatus of claim 2, wherein the first organization module is attached by a slot type connector.

4. The apparatus of claim 2, wherein the first organization module is attached by a post type connector.

5. The apparatus of claim 2, wherein the first organization module further includes at least one connector for connecting additional organization modules.

6. The apparatus of claim 2, further including at least one rear organization module.

7. The apparatus of claim 6, wherein the at least one rear organization module is formed to hold files or paper.

8. The apparatus of claim 2, wherein at lest one of the organization modules includes a cell phone holder, and wherein the cell phone holder includes a charger for the cell phone such that the cell phone may be charged when installed in the cell phone holder of the monitor organizer.

9. The apparatus of claim 2, wherein the frame is adjustable to accommodate monitors of different sizes.

10. An apparatus for use with a display device, comprising:
a connector;
a first organization module connected to a connector; and
a second organization module connected to a connector;
wherein the connector connecting the first organization module and the second organization module extending across the top of the monitor when the apparatus is installed on a monitor.

11. The apparatus of claim 10, wherein at least one of the organization modules is attached in a manner to allow removal from the frame of the apparatus.

12. The apparatus of claim 10, further including at least one rear organization module.

13. The apparatus of claim 12, wherein the at least one rear organization module is formed to hold files or paper.

14. The apparatus of claim 10, wherein the connector is adjustable to accommodate monitors of different sizes.

15. The apparatus of claim 10, wherein at lest one of the organization modules includes a cell phone holder, and wherein the cell phone holder includes a charger for the cell phone such that the cell phone may be charged when installed in the cell phone holder of the monitor organizer.
